(19) United States
(12) Patent Application Publication
(10) Pub. No.: US 2016/0361221 A1
(43) Pub. Date: Dec. 15, 2016

(54) Device to Assist Chiropractic Manipulation and Mobilization

(71) Applicant: Adam Charles Ebbers, Worthington, MN (US)

(72) Inventor: Adam Charles Ebbers, Worthington, MN (US)

(21) Appl. No.: 15/178,911

(22) Filed: Jun. 10, 2016

Related U.S. Application Data
(60) Provisional application No. 62/175,399, filed on Jun. 14, 2015.

(51) Int. Cl. A61H 1/00

(52) U.S. Cl. CPC A61H 1/008; A61H 2201/1253

(57) ABSTRACT

A device for spinal manipulation includes a base fitting within a practitioner's palm, whereby the practitioner's fingers extend beyond the base. The base is secured within the palm by a fabric strap secured around the practitioner's hand. A groove runs centrally along an application side of the base opposite a palm side of the base, the groove being in orthogonal orientation to the practitioner's fingers. A pair of contact bars are affixed to the application side of the base, with the groove positioned between each of the pair of contact bars. Preferably, the contact bars are detachably affixed to the application side of the base, whereby contact bars of varying shape and size can be used. Preferably, the fabric strap is made of elastic material, whereby the device can be rotated about the practitioner's hand or positioned above the practitioner's wrist, when the device is not in use.

### CROSS REFERENCE TO RELATED APPLICATIONS

This application claims the benefit of Provisional Patent Application Ser. No. 62/175,399 filed on 14 Jun. 2015 by the inventor.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to a device intended to assist with spinal manipulation and mobilization performed by chiropractors and other medical practitioners.

### BACKGROUND OF THE INVENTION

Musculoskeletal pain including spinal (back) pain and the like represents a major source of health care expenditures and disability. Various methods and aids have been developed to address this issue. For example, braces, belts, surgical procedures, and therapy devices have been developed and are currently (or previously) available. Much of the spinal pain experienced is described as mechanical in nature and is due to decreased mobility of the spine (or parts thereof) or misalignment of individual spinal segments (vertebrae). Treatment of this condition often requires some form of mobilization or manipulation of the joints and surrounding tissues performed by specialized practitioners, including Chiropractors, Physical Therapists, Osteopaths, and others who have these treatments within their ability. Due to the prevalence of musculoskeletal pain, such practitioners may perform upwards of one hundred treatments each week often using only their hands. This overuse of practitioners' hands can lead to disability and/or deformity in the practitioners' hands and wrists. This leads to the need for an effective way to reduce the stress on the practitioners' hands while providing a safe and effective treatment.

The prior an includes devices that serve similar purposes, including the inventions disclosed by U.S. Pat. No. 4,705,030 and U.S. Pat. No. 8,057,412. These other devices are, however, relatively large, so that the practitioners' entire hand is essentially encased within these other devices, when the devices are in use. Thus, when using these other devices, practitioners are not able use their fingertips to simultaneously palpate a patient. Such palpation can be crucial in applying proper treatment to the patient. The relatively large size of these other devices and the unyielding nature of the structures holding the devices into position on the practitioner's hand also makes it difficult for practitioners to carry these devices with them when not in use. Further, the fully integrated structures of these other devices require these other devices to be completely replaced when surfaces that come into contact with patients become worn. Also, the size and configuration of the surfaces that come into contact with patients cannot be easily varied on these other devices.

### SUMMARY OF THE INVENTION

A device to assist with spinal manipulation embodying the principles of the present invention includes a base that is sized and shaped to fit within a practitioner's palm when the device is in use. When using the device, a practitioner's fingers, thus, extend beyond the base, so the practitioner is able to simultaneously palpate a patient, allowing for more effective and accurate application of chiropractic therapy to the patient. The base of the device embodying the principles of the present invention is held into place on the practitioner's palm, when in use, by a fabric strap. Given the relatively small size of the device and the collapsible nature of the fabric strap, the device can easily be stored in a practitioner's pocket when the device is not in use. In a preferred embodiment of the invention, the fabric strap is made of elastic material, which also allows the practitioner to rotate the device about the practitioner's hand or to slide the device onto the practitioner's wrist or forearm, when the device is not in use.

A groove runs centrally along an application side of the base (the application side of the base being opposite a palm side of the base). The groove is in a generally orthogonal orientation to the practitioner's fingers, when the practitioner's fingers are inserted through the fabric strap. A pair of contact bars and are affixed to the application side of the base with the groove running between each of the pair of contact bars. The pair of contact bars are positioned generally in parallel to the groove. The contact bars and are made of a durable, rigid or semi-rigid material such as rubber, plastic, foam, a like material, or a combination of those materials.

In a preferred embodiment of the invention, each of the pair of contact bars is detachably affixed to the base. This allows contact bars to be replaced when they become worn. This also allows contact bars with differing structures to be substituted onto the base, such as contact bars with an angled contact surface. The practitioner might find that different contact bar structures have particular therapeutic advantages tor treating patients suffering from various difficulties.

### BRIEF DESCRIPTION OF THE SEVERAL VIEWS OF THE DRAWINGS

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a perspective view of one embodiment of the present invention;

FIG. 2 is a side view of one embodiment of the present invention;

FIG. 3 is a bottom of one embodiment of the present invention;

FIG. 4 is an isolated perspective view of one embodiment of the contact bars of the present invention;

FIG. 5 is an isolated perspective view of one embodiment of the base of the present invention;

FIG. 6 is perspective view of alternative embodiment of the present invention;

FIG. 7A is an isolated perspective view of an alternative embodiment of the contact bars of the present invention;

FIG. 7B is an isolated perspective view of an alternative embodiment of the contact bars of the present invention;

FIG. 8 is an isolated perspective view of an alternative embodiment of the base of the present invention; and

FIG. 9 is a perspective view of an embodiment of the present invention in place on a user's hand.

### DESCRIPTION OF THE INVENTION

To provide an understanding of the basic principles of the invention, reference is made to the embodiments shown in the drawings, and specific terms will be employed to describe the same. It should be understood, however, that no limitation of the scope of the invention is thereby intended. Instead, the invention includes any and all such alterations and improvements of the illustrated device that would normally occur to one skilled in the art to which the invention relates.

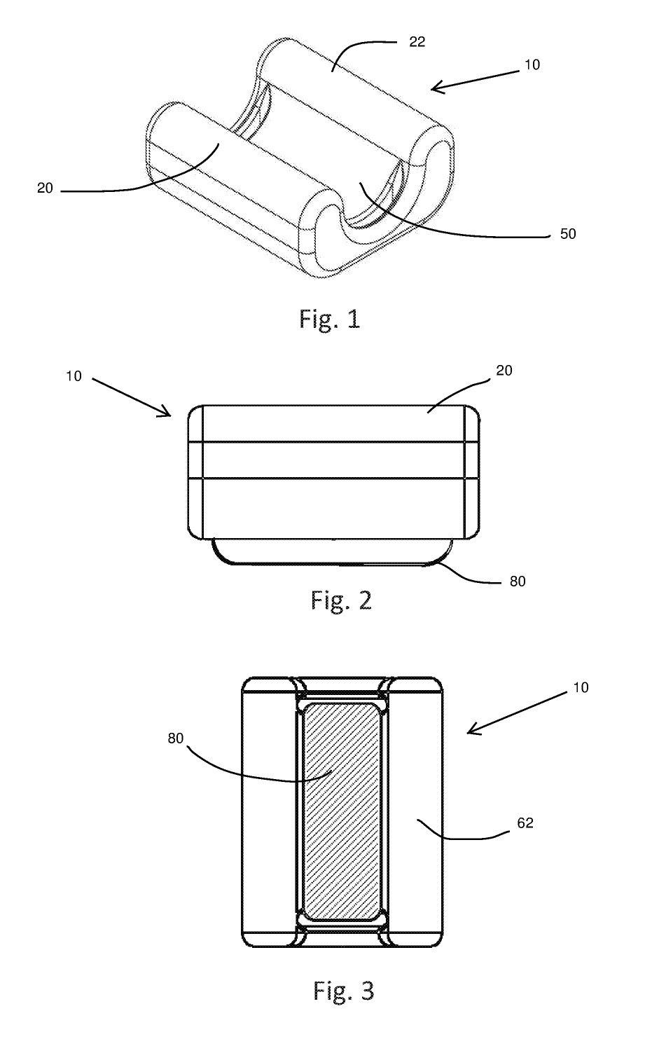

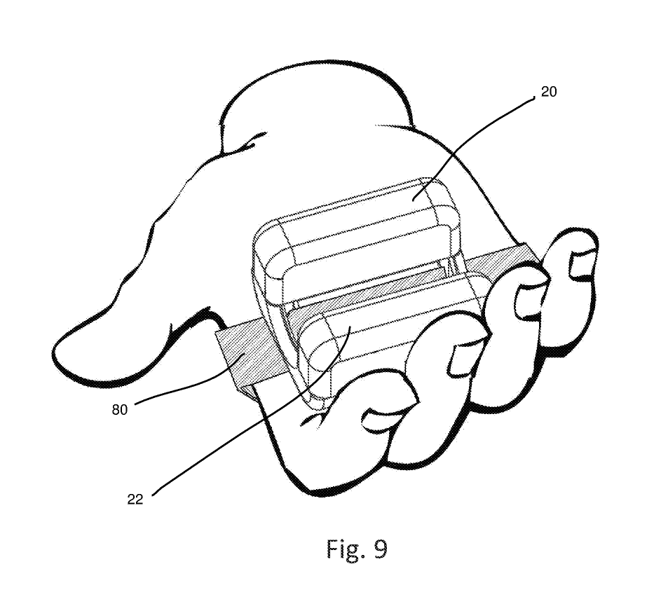

A device 10 in accordance with the present invention is shown in FIGS 1-9. The device 10 includes a base 60 having, in the preferred embodiment shown, a generally rectangular shape. Other shapes for the base 60, including elliptical, circular, square, or trapezoidal, fall within the scope of the present invention. The base 60 is sized and shaped to fit comfortably within a practitioner's palm. With the base 60 seated within the practitioner's palm, a practitioner's fingers are able to extend beyond the base 60 and make contact with a patient, when the device 10 is in use. The base 60 is made from a rigid, durable material, preferably a plastic, although metal, ceramic, wood, or other materials may be used. The base 60 includes a palm side 62 and an application side 64.

A fabric strap 80, which is preferably adjustable in size, is affixed to the base 60. The fabric strap 80 is sized and structured so that it can be secured around a practitioner's hand. Thus, the base 60 is held firmly within the practitioner's palm by the fabric strap 80 when the device 10 is in use. In a preferred embodiment, the fabric strap 80 is constructed from elastic material, which stretches in a fashion that allows the practitioner to rotate the device 10 around the practitioner's hand or to slide the device 10 above a practitioner's wrist, when the device 10 is not in use.

A groove 50 runs centrally along the application side 64 of the base 60 in generally orthogonal orientation to the practitioner's fingers, when the practitioner's fingers are inserted through the fabric strap 80. A pair of contact bars 20 and 22 are affixed to the application side 64 of the base 60 with the groove 50 running between each of the pair of contact bars 20 and 22. The pair of contact bars 20 and 22 are positioned generally in parallel to the groove 50, one of the pair of contact bars 20 is also positioned generally parallel to the other one of the pair of contact bars 22. The contact bars 20 and 22 are made of a durable, rigid or semi-rigid material such as rubber, plastic, foam, a like material, or a combination of those materials.

The contact bars 20 and 22 may be integrally constructed with the base 60, or the contact bars 20 and 22 may permanently affixed to the application side 64 of the base 60. In alternative embodiments, the contact bars 20 and 22 may be detachably affixed to the application side 64 of the base 60.

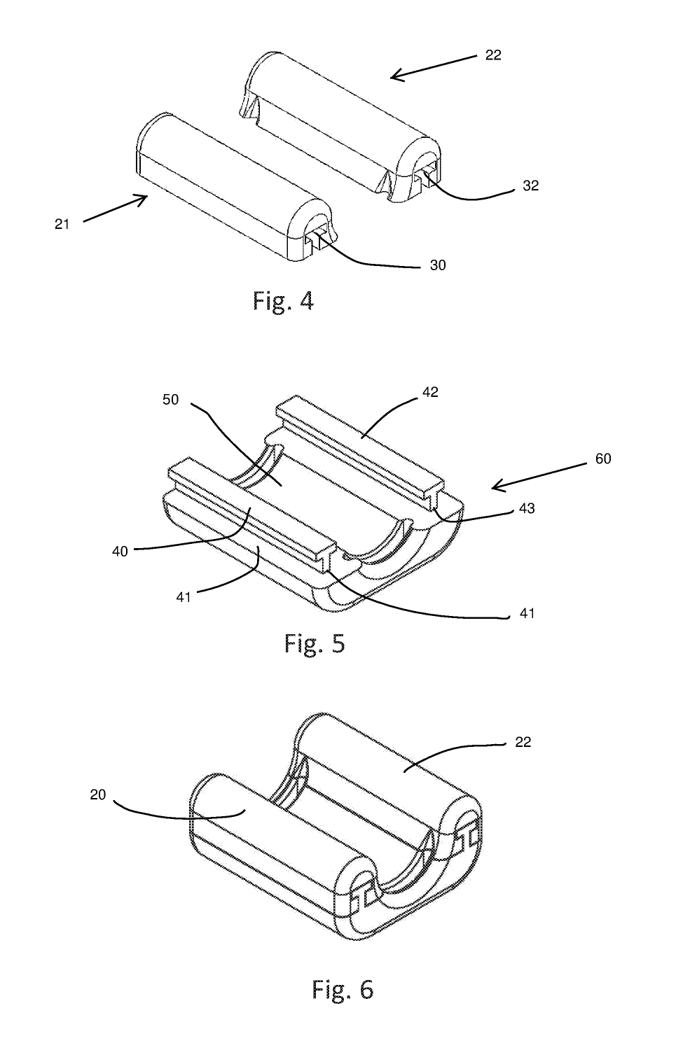

In an embodiment of the device 10 shown in FIGS. 4-6, each of the pair of contact bars 20 and 22 are detachably affixed to the base 60 by means of a pair of male tabs having a generally T-shaped cross-sectional configuration 40 and 42. Lower ends 41 and 43 and of the T-shaped male tabs 40 and 42 are affixed to the application, side 64 of the base 60. In this embodiment, each of the pair of contact bars 20 and 22 also include a female slot having a generally T-shaped cross-sectional configuration 30 and 32. The T-shaped female slots 30 and 32 are sized and positioned to snuggly receive the T-shaped male tabs 40 and 42 when the practitioner detachably affixes the contact bars 20 and 22 onto the base 60 by sliding one of the T-shaped male tabs 40 and 42 into one of the T-shaped female slots 30 and 32.

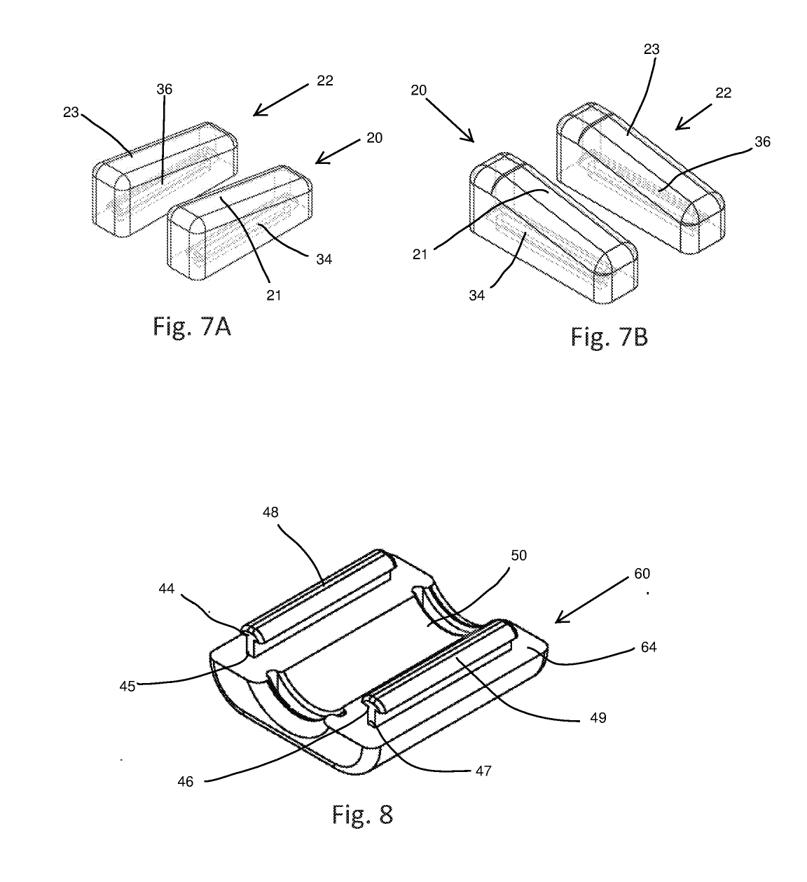

In another alternative embodiment shown in FIGS. 7-8, the contact bars 20 and 22 are detachably affixed to the base 60 by means of a pair of male tabs having a generally mushroom-shaped cross-sectional configuration 44 and 46. Lower ends 45 and 47 and of the mushroom-shaped male tabs 44 and 46 are affixed to the application side 64 of the base 60. The upper portions of the male mushroom tabs 48 and 49 are made of temporarily compressible material. In this embodiment, each of the pair of contact bars 20 and 22 also include a female slot having a generally mushroom-shaped cross-sectional configuration 34 and 36. The mushroom-shaped female slots 34 and 36 are sized and positioned to snuggly receive the mushroom-shaped male tabs 44 and 46 when the practitioner detachably affixes the contact bars 20 and 22 onto the base 60 by snapping one of the mushroom-shaped male tabs 44 and 46 into one of the mushroom-shaped female slots 34 and 36. Similar means for detachably affixing the contact bars 20 and 22 that would be familiar to those skilled in the art fall within the scope of the present invention.

Alternative embodiments of the present invention, as shown in FIGS. 7 and 7A, include contact bars 20 and 22 with patient-contact surfaces 21 and 23 variously angled with respect to the base 60. Such angled patient-contact surfaces 21 and 23 may offer therapeutic advantages to the practitioner when using the device 10 to treat patients. Other shapes and sizes for contact bars 20 and 22 that would be of therapeutic value fall within the scope of the present invention.

The device 10 is to be used by practitioners who are trained in spinal manipulation and mobilization. The device 10 is to be placed with the contact bars 20 and 22 touching the patient in a manner similar to the traditional technique of hand/fist contact. One technique that may utilize this device 10 is currently used by chiropractors and is commonly referred to as an “anterior thoracic adjustment” or a “supine thoracic adjustment” Using the device 10 with this technique, the practitioner would first secure the device 10 to the palm of their hand with the fabric, strap 80. With the patient sitting, the practitioner would place the contact bars 20 and 22 on area of a patient's spine that will be adjusted and lay the patient supine on the device 10 and the practitioner's hand. The patient will then place their hands behind their neck with elbows pointed forward. The practitioner will then contact the patient's arms with his/her free hand and arm and deliver a thrust from anterior to posterior or as determined by the practitioner. Since technique can vary from practitioner to practitioner, it is understood that the device 10 can be utilized in any manipulation or mobilization as determined by the individual practitioner.

Since the size and shape of the patient can vary, it is understood that the size and shape of the device 10 and its components can also vary in size and shape from that shown. Since the size of the practitioner and the techniques may vary, the size and shape of the device and its components can be modified to suit the practitioner's needs. Although the device 10 and its components may vary, they will conform to the general depictions in FIGS. 1-9.

What is claimed is:

1. a device to assist a medical practitioner in spinal manipulation, the device comprising:
a. a base, preferably having a rectangular shape, sized to fit comfortably within a practitioner's palm;
b. a fabric strap affixed to the base, the fabric strap being sized and structured so that it can be secured around a practitioner's hand, holding the base firmly within the practitioner's palm when the device is in use;
c. a groove running centrally along an application side of the base (the application side of the base being opposite a palm side of the base), the groove being in generally orthogonal orientation to a practitioner's fingers, when the practitioner's fingers are inserted through the fabric strap; and
d. a pair of contact bars affixed to the application side of the base, with the groove running between each of the pair of contact bars, each of the pair of contact bars positioned roughly in parallel to each her and in parallel to the groove running between them.

2. The device of claim 1, wherein the fabric strap is constructed from elastic material, whereby the practitioner is able to comfortably rotate the device so that the base is positioned on the back of the hand (when the device is not in use), and whereby the practitioner, alternatively, is able to comfortably slide the device above a practitioner's wrist (when the device is not in use).

3. The device of claim 1, wherein patient-contact surfaces on each of the pair of contact bars are angled with respect to the base, whereby these angled patient-contact surfaces may offer therapeutic advantages to the practitioner when using the device to treat patients.

4. The device of claim 3, wherein the fabric strap is constructed from elastic material, whereby the practitioner is able to comfortably rotate the device so that the base is positioned on the back of the hand (when the device is not in use), and whereby the practitioner, alternatively, is able to comfortably slide the device above a practitioner's wrist (when the device is not in use).

5. The device of claim 1, wherein each of the pair of contact bars is detachable affixed to the base by means an attachment system, the attachment system comprising:
a. a pair male tabs with a generally T-shaped cross-sectional configuration, wherein lower ends of the T-shaped male tabs are affixed to the application side of the base in parallel with each other and on either side of the groove on the application side of the base;
b. a pair of female slots with a generally T-shaped cross-sectional configuration molded into each of the pair of contact bars, the T-shaped female slots being sized and positioned to snuggly receive the T-shaped male tabs;
c. wherein the practitioner may detachably affix each of the contact bars onto the base by sliding one of the T-shaped female slots onto one of the T-shaped male tabs;
d. whereby the practitioner can replace worn contact bars.

6. The device of claim 5, wherein the fabric strap is constructed from elastic material, whereby the practitioner is able to comfortably rotate the device so that the base is positioned on the back of the hand (when the device is not in use), and whereby the practitioner, alternatively, is able to comfortably slide the device above a practitioner's wrist (when the device is not in use).

7. The device of claim 5, wherein patient-contact surfaces on each of the pair of contact bars are angled with respect to the base, whereby these angled patient contact surfaces may offer therapeutic advantages to the practitioner when using the device to treat patients.

8. The device of claim 7, wherein the fabric strap is constructed from elastic material, whereby the practitioner is able to comfortably rotate the device so that the base is positioned on the back of the hand (when the device is not in use), and whereby the practitioner, alternatively, is able to comfortably slide the device above a practitioner's wrist (when the device is not in use).

9. The device of claim 1, wherein each of the pair of contact bars is detachable affixed to the base by means an attachment system, the attachment system comprising:
a. a pair of male tabs with a generally mushroom-shaped cross-sectional configuration, wherein lower ends of the mushroom-shaped male tabs are affixed to the application side of the base in parallel with each other and on either side of the groove on the application side of the base, and wherein upper ends off the mushroom-shaped male tabs are made of temporarily compressible material;
b. a pair of female slots with a generally mushroom-shaped cross-sectional configuration molded into each of the pair of contact bars, the mushroom-shaped female slots being sized and positioned to snuggly receive the mushroom-shaped male tabs;
c. wherein the practitioner may detachably affix each of the contact bars onto the base by snapping one of the mushroom-shaped female slots onto one of the mushroom-shaped male tabs;
d. whereby the practitioner can replace worn contact bars.

10. The device of claim 9, wherein the fabric strap is constructed from elastic material, whereby the practitioner is able to comfortably rotate the device so that the base is positioned on the back of the hand (when the device is not in use), and whereby the practitioner, alternatively, is able to comfortably slide the device above a practitioner's wrist (when the device is not in use).

11. The device of claim 9, wherein patient-contact surfaces on each of the pair of contact bars are angled with respect to the base, whereby these angled patient-contact surfaces may offer therapeutic advantages to the practitioner when using the device to treat patients.

12. The device of claim 11, wherein the fabric strap is constructed from elastic material, whereby the practitioner is able to comfortably rotate the device so that the base is positioned on the back of the hand (when the device is not in use), and whereby the practitioner, alternatively, is able to comfortably slide the device above a practitioner's wrist (when the device is not in use).
